(19) United States
(12) Patent Application Publication
(10) Pub. No.: US 2018/0169717 A1
(43) Pub. Date: Jun. 21, 2018

(54) METHODS AND APPARATUS TO TREAT WORKPIECES WITH PROCESS FLUID

(71) Applicant: Ecoclean GmbH, Filderstadt (DE)

(72) Inventors: Hermann-Josef David, Monschau (DE); Egon Käske, Aachen (DE)

(21) Appl. No.: 15/895,531

(22) Filed: Feb. 13, 2018

Related U.S. Application Data
(63) Continuation-in-part of application No. PCT/EP2016/066507, filed on Jul. 12, 2016.

(30) Foreign Application Priority Data
Aug. 18, 2015 (DE) 10 2015 215 728.8

(51) Int. Cl. B08B 5/04; B08B 3/08; B08B 5/02; B08B 3/02

(52) U.S. Cl. CPC B08B 5/04; B08B 3/08; B08B 2203/0229; B08B 3/02; B08B 5/02

(57) ABSTRACT

Methods and apparatus to treat workpieces with process fluid are disclosed. A disclosed example installation for the treatment of a workpiece with a process fluid includes a workpiece receptacle region for receiving the workpiece, an impingement unit for impinging the workpiece in the workpiece receptacle region with the process fluid, and a closable operating chamber that is provided with at least a partial vacuum. The disclosed installation also includes a housing disposed in an interior space of the operating chamber, where the housing includes a suction connector, and where the housing is to surround a workpiece that is received in the workpiece receptacle region. The disclosed installation also includes a suction device that is coupled to the suction connector via a suction line, wherein at least one of the housing includes a first portion that is displaceable for disposing workpieces in the workpiece receptacle region relative to a second portion of the housing, or the operating chamber includes a first chamber part having the portion of the housing fixed therein, and a further chamber part that is displaceable between a closed and an opened position relative to the first chamber part, where the operating chamber includes a further portion of the housing fixed therein for the workpiece receptacle region in the opened position to be released for feeding and discharging workpieces and in the closed position to lock a workpiece that is disposed in the workpiece receptacle region in the housing.

### RELATED APPLICATIONS

This patent arises as a continuation-in-part of International Patent Application No. PCT/EP2016/066507, which was filed on Jul. 12, 2016, which claims priority to German Patent Application No. 10 2015 215 728, which was filed on Aug. 18, 2015. The foregoing International Patent Application and German Patent Application are hereby incorporated herein by reference in their entireties.

### FIELD OF THE DISCLOSURE

This disclosure relates generally to workpiece treatment, and, more particularly, to methods and apparatus to treat workpieces with process fluid.

### BACKGROUND

When workpieces are processed, installed, or assembled after cleaning, in some applications liquid media should be removed from the workpieces. To this end, the workpieces are dried, such that drying of workpieces can encompass the removal of liquid media received on and/or adhering to a workpiece that is received.

To dry the workpieces in industrial manufacturing, drying ovens are employed to impinge the workpieces with heat to evaporate liquid media adhering to the workpieces. In applications where workpieces have portions that can attract or adhere (e.g., “scoop up”) liquid from liquid baths, a relatively large amount of energy and time is typically required to dry the workpieces by use of drying ovens. In some applications, to dry industrial manufacturing workpieces, the workpieces are moved along a workpiece axis or a plurality of workpiece axes via handling robots while at least one surface of a workpiece is simultaneously impinged with blown air.

### BRIEF DESCRIPTION OF THE DRAWINGS

FIG. 1 illustrates a first example installation for the treatment of a workpiece with a process fluid, in a first operating state.

FIG. 2 illustrates the first example installation in a second operating state that is different from the first operating state.

FIG. 3 illustrates the first example installation in a third operating state that is different from the first and second operating states.

FIG. 4 illustrates a second example installation for the treatment of a workpiece with a process fluid.

FIG. 5 illustrates a third example installation for the treatment of a workpiece with a process fluid.

FIG. 6 illustrates a fourth example installation for the treatment of a workpiece with a process fluid.

FIG. 7 illustrates a fifth example installation for the treatment of a workpiece with a process fluid.

FIG. 8 illustrates an example nozzle tool that can be implemented in the fifth example installation for the treatment of a workpiece with a process fluid.

FIG. 9 illustrates a sixth example installation for the treatment of a workpiece with a process fluid.

FIG. 10 illustrates a seventh example installation for the treatment of a workpiece with a process fluid.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus to treat workpieces with process fluid are disclosed. Examples disclosed herein relate to an installation for the treatment of a workpiece with a process fluid. The installation includes a workpiece receptacle region for receiving the workpiece, and a unit for impinging the workpiece in the workpiece receptacle region with the process fluid.

A known installation is shown in EP 2 246 129 A2, for example. In this known installation, workpieces are impinged with liquid media in industrial manufacturing processes for the former to be cleaned of dirt particles or for the surfaces of the workpieces to be treated with chemical substances. Dirt particles and liquid droplets can compromise the functioning of industrially-made products such as, for example, injection nozzles for internal combustion engines. The cleanliness of workpieces in industrial production processes is, thus, of great importance. Cleaning installations in which the workpieces are impingeable with liquid media such as, for example, water preferably having cleaning additives, or with a process liquid that contains hydrocarbons, are employed for cleaning workpieces in industrial manufacturing.

When workpieces are further processed, installed, or assembled after cleaning, it is sometimes necessary to remove the aforementioned liquid media from the workpieces. To this end, the workpieces are dried. As used herein, drying of workpieces is understood to be significant reduction (e.g., removal) of liquid media from a workpiece that is received with the workpiece or adheres to the workpiece.

Drying ovens in which the workpieces are impinged with heat to evaporate liquid media adhering to the workpieces are sometimes employed in industrial manufacturing. In applications where workpieces have portions and/or geometry that can retain liquid from liquid baths, a relatively large amount of energy and time is typically necessary to dry the workpieces via a drying method. Further, to dry workpieces in industrial manufacturing, the workpieces are moved about a workpiece axis and/or a plurality of workpiece axes via handling robots while surface(s) of the workpieces are impinged with blown air.

Moreover, to dry workpieces that are treated with a cleaning liquid it is known for said workpieces to be impinged with a vacuum in a chamber that is closable in an air-tight manner. Such a known installation for drying workpieces is mentioned in DE 42 37 335 A1. In particular, remnants of cleaning fluid adhering to a workpiece are evaporated by evacuating the chamber. To remove the cleaning fluids that are received in bores and blind bores during cleaning, this known installation includes blower nozzles to generate air jets. Workpieces are blown down by way of these air jets. As a result, the cleaning liquid that is received in the bores and blind bores of a workpiece is atomized.

Typically, a relatively large amount of energy is required for generating heat, providing a vacuum, and producing blown air in known systems. Accordingly, drying of workpieces in industrial manufacturing can result in relatively high costs.

Examples disclosed herein provide an installation for the relatively residual-free treatment of a workpiece with a process fluid, and provide methods to treat workpieces with a process fluid, such that process-fluid remnants on the workpiece are significantly reduced (e.g., removed) to a relatively significant extent after the treatment.

Examples disclosed herein include a closable operating chamber that is impingeable with at least a partial vacuum (i.e., a part-vacuum). Example closable operating chambers include a housing disposed in an interior space of the operating chamber, and a suction connector. In some examples, the housing surrounds a workpiece that is received in the workpiece receptacle region, where the suction connector is coupled to a suction device via a suction line.

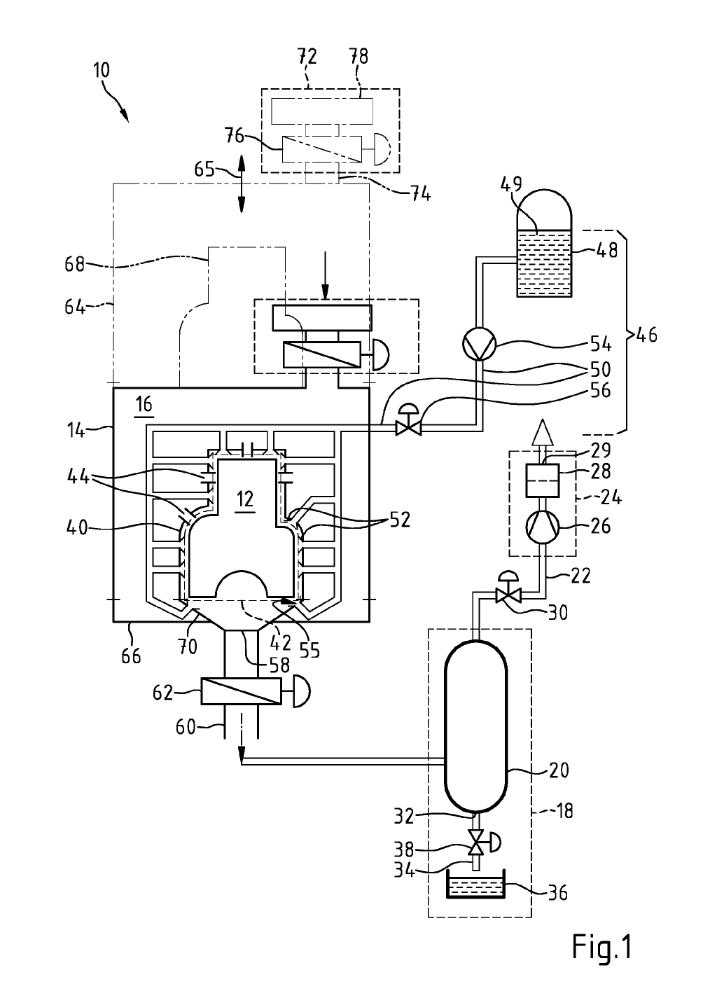

An example installation 10 shown in FIG. 1 for the treatment of a workpiece 12 includes an operating chamber 14 with an evacuatable interior space 16. In this example, the operating chamber 14 is a vacuum chamber that is closable in a relatively fluid-tight manner. The example installation 10 also includes a suction device 18 with an evacuatable vacuum container 20 that is coupled to an evacuation unit via a fluid line 22. According to the illustrated example, the evacuation unit includes an exit 29. The example evacuation unit 24 includes a suction pump 26 and a liquid separator 28. By use of a shut-off valve 30 that is disposed in the line 22, the flow path for fluid between the vacuum container 20 and the evacuation unit 24 can be selectively released and blocked, in this example. The example suction pump 26 generates a vacuum in the vacuum container 20. In some examples, the residual gas pressure for the vacuum in the vacuum container 20 is, preferably, between approximately 20 millibar (mbar) and 100 mbar. To relieve the installation 10 of liquid substances such as, for example, cleaning liquids for cleaning workpieces 12, gaseous fluid is conveyed via the suction pump 26 and the gaseous fluid is then guided through a liquid separator 28 that is coupled to the pressure connector of the suction pump 26. In this example, the vacuum container 20 includes a connector 32 to discharge liquid that has accumulated therein via a fluid line 34 into a receptacle container 36. In this example, the fluid line 34 can be selectively released or blocked via a shut-off valve 38.

According to the illustrated example, a housing 40 of the installation 10 has a workpiece receptacle region 42 in which a workpiece 12 is disposed. The example workpiece receptacle region 42 can be enclosed in a contour-hugging manner, for example. The example housing 40 includes a housing wall having passage openings 44 for gaseous fluid. In particular, the passage openings 44 are passages disposed in the operating chamber 14, for gaseous fluid to flow from the evacuatable interior space 16 of the operating chamber 14 and into the interior of the housing 40, for example. The example installation 10 also includes a unit (e.g., an impingement unit) 46 to impinge the workpiece 12 that is disposed in the workpiece receptacle region 42 with a process fluid in the housing 40. In this example, the unit 46 includes a container 48 with process fluid 49. The container 48, via a fluid line 50 being coupled to nozzles 52 that have corresponding nozzle openings 55, which are disposed in the interior of the housing 40 in this example. A pressure generator 54 of the illustrated example is disposed in the fluid line 50. The fluid line 50, via the shut-off valve 56, can be selectively released and blocked. The example housing 40 that is disposed in the operating chamber 14 includes a suction connector 58 which is connected to the evacuatable vacuum container 20 of the suction device 18 via a suction line 60. According to the illustrated example, a valve 62, which is configured as a flap valve by which a flow path for fluid through the suction line 60 can be selectively released and blocked, is disposed in the suction line 60. The example valve 62 is implemented for relatively short switching times and can, therefore, abruptly release the opening cross section of the suction line 60, within a time interval of the duration Δt≤1 second(s), and preferably within a time interval of the duration Δt≤0.1 s in some examples.

The example operating chamber 14 of the installation 10 is implemented in two parts and has a hood-shaped chamber part 64 that, by way of a motion element (not shown) in a direction generally indicated by a double arrow 65, can be raised and lowered relative to a further chamber part 66. The housing 40 is likewise designed in multiple parts. For example, the housing 40 includes a portion 68 that is displaceable relative to a portion 70. The portion 70 of the housing 40 of the illustrated example is positioned to be locationally or positionally fixed in relation to the chamber part 66. Accordingly, the portion 68 of the housing 40 is to be locationally fixed relative to the hood-shaped chamber part 64.

According to the illustrated example, the hood-shaped chamber part 64 can be moved via the motion element between closed and opened positions. The example workpiece receptacle region 42 is released for feeding and discharging workpieces 12 in the opened position. In the closed position, a workpiece 12 that is disposed in the workpiece receptacle region 42 is locked in and/or constrained to the housing 40. The example operating chamber 14 includes a ventilation unit 72 with a fresh air duct 74, which by way of a valve 76 that is configured as a flap valve in this example, can be selectively blocked and released. To reduce and/or minimize the generation of noise when venting the operating chamber, a silencer 78 is located on that side of the valve 76 that faces away from the operating chamber 14. To prevent or reduce dust and/or dirt particles from entering into the operating chamber 14 when the operating chamber is being vented, an air filter can also be, additionally or alternatively, provided to the silencer 78 in the ventilation unit 72.

According to the illustrated example, the installation 10 is implemented to initially clean and, subsequently, dry workpieces 12 in successive operating modes. For cleaning, the workpiece 12 is impinged with process fluid from the container 48, said process fluid being guided through the fluid line 50 and the nozzles 52 to the workpiece 12. The process fluid herein wets the surface of the workpiece 12. Said process fluid is preferably a cleaning liquid which enables contaminations on the surface of the workpiece 12 to be chemically dissolved.

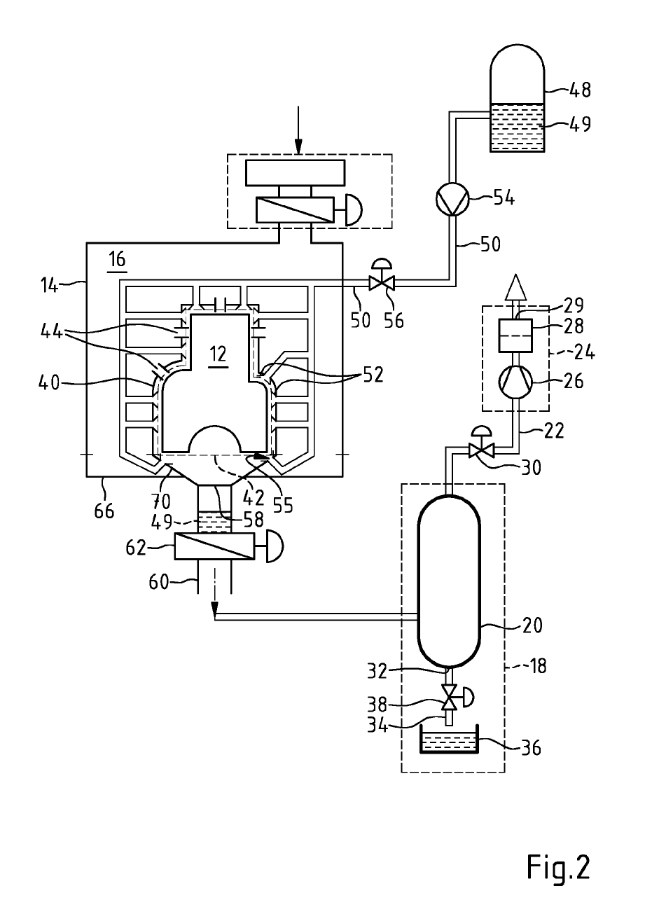

FIG. 2 illustrates the workpiece 12 in the example installation 10 after the workpiece 12 has been impinged with the process fluid 49. In this example, the process fluid 49 has accumulated before (e.g., upstream of) the valve 62. According to the illustrated example, the shut-off valve 56 of the fluid line 50 is closed and the valve 62 of the line and the vacuum container 20 are evacuated. Further, the valve 76 of the ventilation unit 72 is opened in this example. The evacuation unit 24 of the illustrated example is shut off and/or isolated from the vacuum container 20. By opening the valve 62 in the suction line 60, a vacuum that is preferably approximately 1 bar relative to atmosphere is rapidly applied to the suction connector 58. As a result, the process liquid accumulated in the portion 70 of the housing 40 is then suctioned into the vacuum container 20.

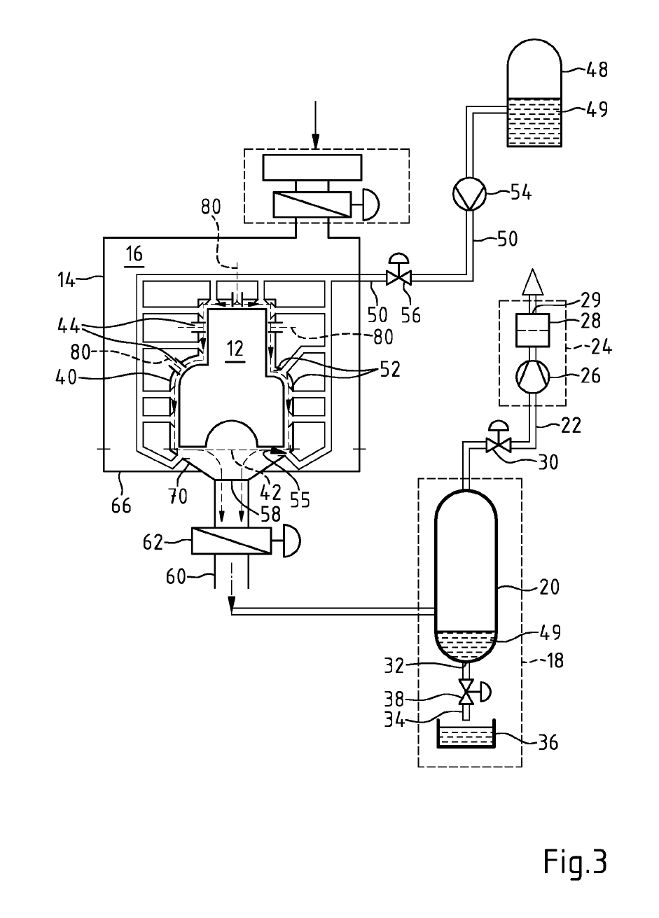

As is shown in FIG. 3, a fluid flow 80 that enters through the openings 44 in the housing wall and runs to the suction connector 58 and, by way of the suction line 60, is guided into the vacuum container 20 from the housing 40. In this example, because the smallest cross section of the suction line 60 is larger than the sum of the passage areas of the openings 44 in the housing wall, it can be achieved in the case of a sufficiently large pressure differential Δp=pI−pV between the pressure pI within the interior space 16 of the operating chamber 14 and the pressure pV within the vacuum container 20, such as for example Δp≈1/2pI≈0.5 bar, that the velocity of the fluid flow 80 at which the gaseous fluid flows from the interior space 16 of the operating chamber 14 into the housing 40 with the workpiece 12 disposed therein can approach the speed of sound.

In some examples, the workpiece 12 that is disposed in the housing 40 of the operating chamber 14 can be an engine block. In such examples, it can be favorable for a volume of the vacuum container 20 to be approximately 2 meters cubed (m³). In principle, however, the volume of the vacuum container 20 can be smaller when the dimensions of the housing 40 are adapted to correspondingly smaller workpieces 12, such as crankshafts or camshafts, for example.

The fluid flow 80 of the interior of the housing 40 impinges the surface of the workpiece 12 that is disposed in the workpiece receptacle region 42 in a manner similar to that of blown air. The cleaning liquids that are received on the surface of the workpiece 12 and retained in interior spaces (e.g., scooping parts/portions) of the workpiece 12 are picked up by the fluid flow 80 and moved through the suction connector 58 via the suction line 60 and into the vacuum container 20.

The opened valve 76 of the ventilation unit 72 facilitates that the fluid flow 80 that impinges the workpiece 12 in the workpiece receptacle region 42 decreases only by the extent to which the vacuum is reduced in the vacuum container 20. In particular, by way of the ventilation unit 72, ambient air can continuously flow into the operating chamber 14 through the opened valve 76, for example.

When the valve 76 of the ventilation unit 72 is closed when a vacuum is applied to the suction connector 58, the fluid flow 80 in the interior of the housing 40 is present until a pressure equilibrium has been established between the vacuum container 20 and the interior of the housing 40. In this example, the fluid flow 80 can only be continued in that the operating chamber 14 is vented through the fresh air duct 74 by way of the valve 76.

In some examples, it is possible for the workpiece 12 that is received in the workpiece receptacle region 42 to be subjected to vacuum drying in that, with the valve 76 of the ventilation unit 72 closed and the shut-off valve 56 of the fluid line closed, the shut-off valve 30 between the vacuum container 20 and the evacuation unit 24 can be opened for the operating chamber 14 via the evacuation unit 24, thereby evacuating to a residual pressure that can be lower than the vapor pressure of the process fluid on and within portions of the workpiece 12.

When the pressure, p, in the interior of the operating chamber 14 drops below the vapor pressure of the cleaning fluids that adhere to a workpiece 12 disposed in the workpiece receptacle region 42, a consequence is that a respective process fluid can boil. Accordingly, the process fluid then evaporates rapidly and, via the evacuation unit 24, is suctioned through the suction line 60 from the interior space 16 of the operating chamber 14 to optionally accumulate in the liquid separator 28 in the evacuation unit 24, for example.

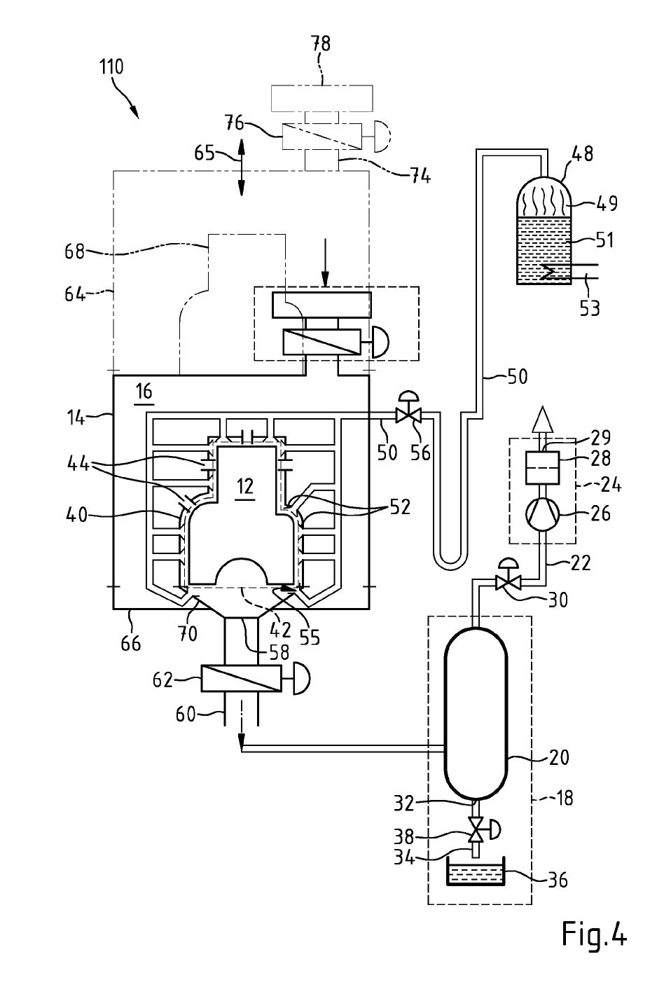

FIG. 4 shows a second example installation 110 for the treatment of a workpiece with a process fluid. In as far as the functional groups and elements of the installation 110 shown in FIG. 4 correspond to functional groups and elements from FIG. 1, FIG. 2 and FIG. 3, the functional groups and elements are identified by the same numerals as reference signs. The example installation 110 includes a container 48 for a liquid 51, which can be heated by way of a heating unit 53 to generate a vaporous process fluid 49.

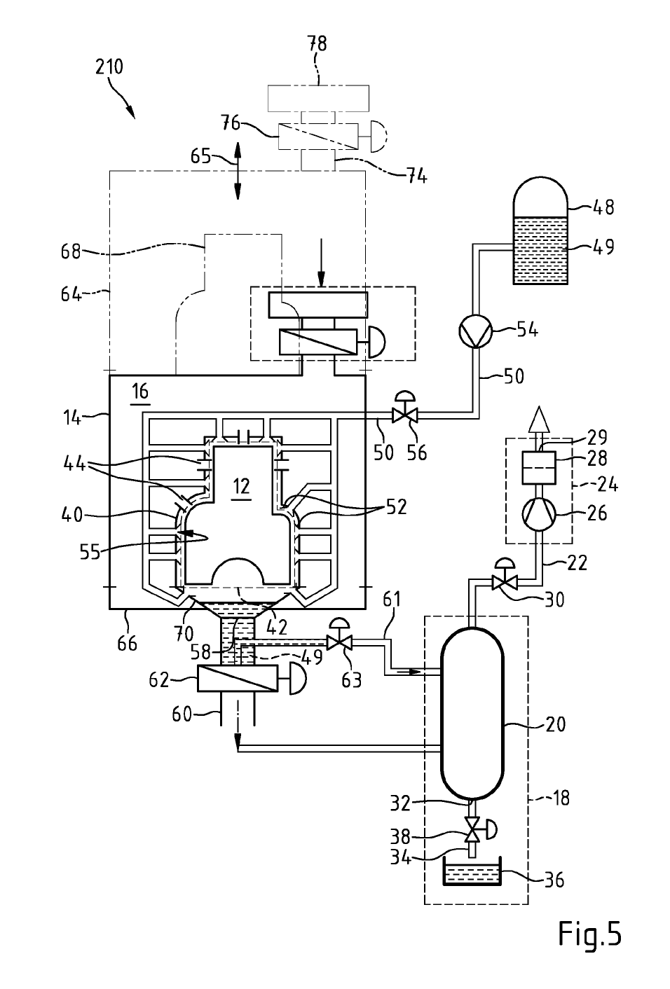

FIG. 5 shows a third example installation 210 for the treatment of a workpiece with a process fluid. In as far as the functional groups and elements of the installation 210 shown in FIG. 5 correspond to functional groups and elements from FIG. 1, FIG. 2 and FIG. 3, said functional groups and elements are identified by the same numerals as reference signs. According to the illustrated example of FIG. 4, there is a bypass line 61 with a shut-off valve 63 in the installation 210, by way of which bypass line 61 the housing 40 can be coupled to the vacuum container 20 even when the valve 62 is closed, for example. This measure enables a pre-suctioning of process liquid from the housing 40.

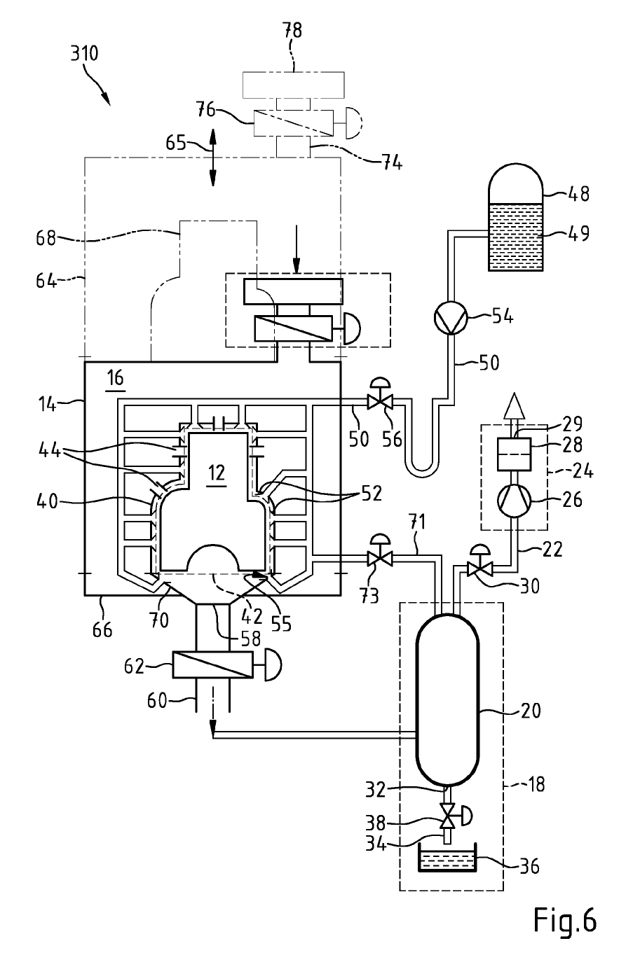

FIG. 6 shows a fourth example installation 310 for the treatment of a workpiece with a process fluid. In as far as the functional groups and elements of the installation 310 shown in FIG. 6 correspond to corresponding functional groups and elements from FIG. 1, FIG. 2 and FIG. 3, the functional groups and elements are identified by the same numerals as reference signs. In this example, there is a fluid line 71 in the installation 310, where the fluid line 71 connects the vacuum container 20 to the fluid line 50, and a shut-off valve 73 in the fluid line 71. The fluid line 71 of the illustrated example enables an evacuation of the fluid line 50 even when the valve 62 is closed.

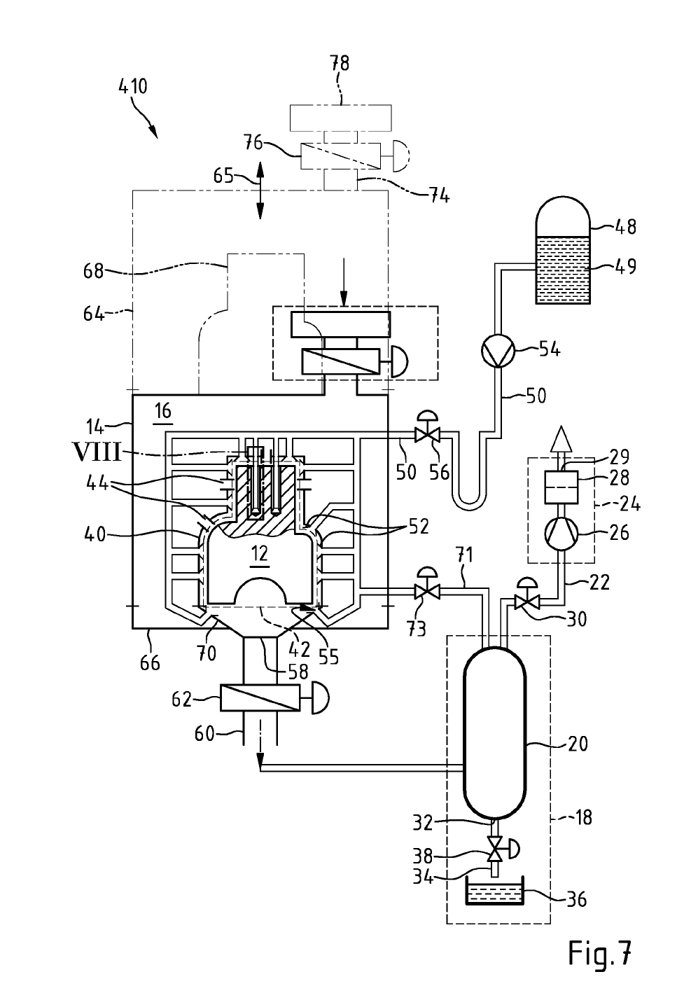

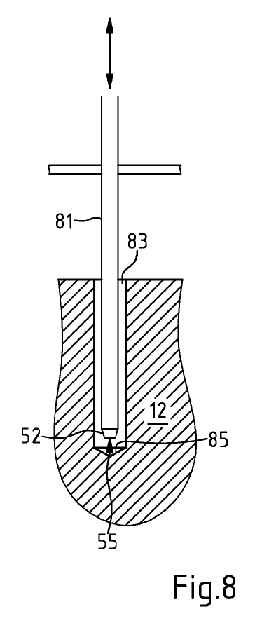

FIG. 7 shows a fifth example installation 410 for the treatment of a workpiece with a process fluid. In as far as the functional groups and elements of the installation 410 shown in FIG. 7 correspond to functional groups and elements from FIG. 1, FIG. 2 and FIG. 3, the functional groups and elements are identified by the same numerals as reference signs. FIG. 8 is an enlarged view of a portion VIII of the installation 410 having the unit 46 for impinging the workpiece 12 with a process fluid 49. The unit 46 for impinging the workpiece 12 with a process fluid here has a lance-shaped nozzle tool 81 that can be disposed in a recess and/or a bore 83 of the workpiece 12 and has at least one nozzle 52 with a nozzle opening 55 in this example. Cleaning fluid can be injected in this example via the unit 46 into a recess and/or a bore 83 to process residue present on a base 85 of the recess or bore, thereby washing the residue out.

For the fluid line 50 and the nozzle tool 81 having the nozzles 52 to be emptied, the valve 56 in the fluid line 50 is closed and the valve 63 in the bypass line 61 is opened, in this example. As a result, process fluid 49 that has been deposited in a bore 83 and/or in a recess is also suctioned by way of the fluid line 50 and the nozzle tool 81 with nozzles 52 and guided into the vacuum container 20. This example implementation enables the process fluid 49 that has already been removed from the workpiece 12 from having to be evaporated in subsequent vacuum drying of the workpiece 12 in the operating chamber 14.

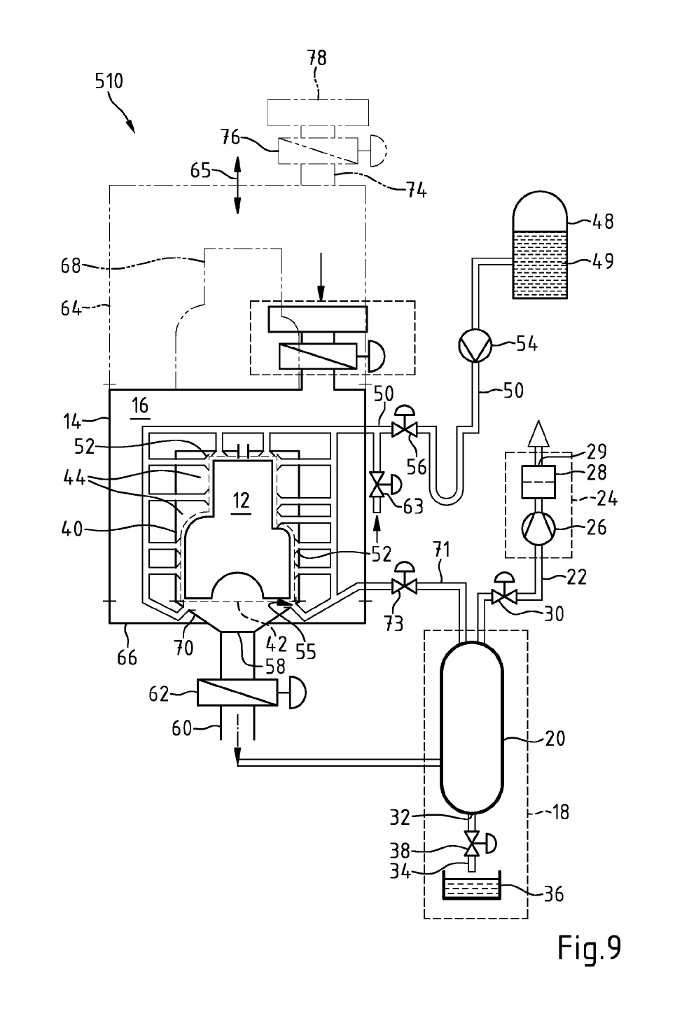

FIG. 9 shows a sixth example installation 510 for the treatment of a workpiece 12 with a process fluid 49. In as far as the functional groups and elements of the installation 510 shown in FIG. 9 correspond to corresponding functional groups and elements from FIG. 1, FIG. 2 and FIG. 3, the functional groups and elements are identified by the same numerals as reference signs. According to the illustrated example, the wall of the housing 40 is not disposed in a contour-hugging manner in relation to the workpiece 12. Accordingly, there is more space available for the treatment of the workpiece 12 with the process fluid 49 in the housing 40. It is also noted that such a construction mode not being contour-hugging in relation to a workpiece 12 can be produced in a very cost-effective manner.

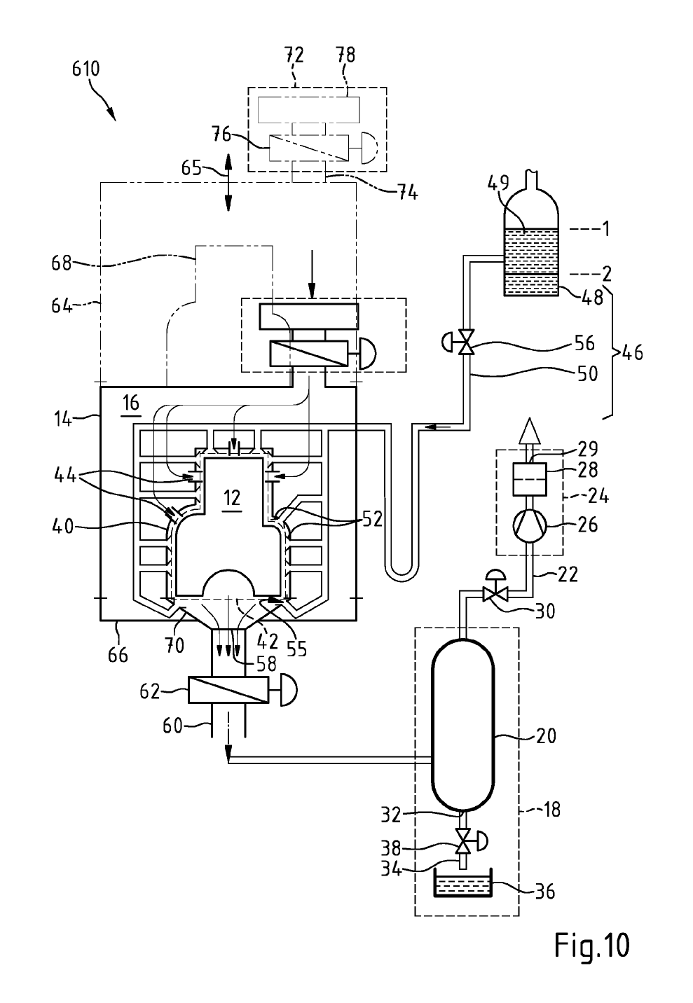

FIG. 10 shows a seventh example installation 610 for the treatment of a workpiece with a process fluid. In as far as the functional groups and elements of the installation 610 shown in FIG. 10 correspond to corresponding functional groups and elements from FIG. 1, FIG. 2 and FIG. 3, the functional groups and elements are identified by the same numerals as reference signs.

In the installation 610, process fluid 49 in the form of a cleaning liquid for impinging the workpiece 12 with the process fluid can be suctioned in from the container 48 through the fluid line 50 via the nozzles 52 of the unit 46. To this end, the workpiece 12 is disposed in the workpiece receptacle region 42 and the hood-shaped chamber part 64 is lowered onto the chamber part 66, for example. The valve 76 in the ventilation unit 72 is closed here in this example. According to the illustrated example, the vacuum container 20 of the suction device 18 is evacuated to a vacuum of p 950 mbar. The valve 62 that is configured as a flap valve is then opened in this example. On account thereof, process fluid 49, by virtue of the pressure differential between the fluid reservoir in the container 48 and the interior space 16 of the operating chamber 14, is suctioned from the container 48. Proceeding from the filling volume 1, the process fluid 49 then flows through the fluid line 50 until the filling volume 2 is reached. From the filling volume 2 onward, gaseous fluid in the form of air expels the cleaning liquid from the fluid line 50 and is suctioned from the nozzles 52 into the fluid line 50 from the container 48. In that the valve 76 in the ventilation unit 72 thereafter is abruptly opened, an airflow is created in the operating chamber 14 between the wall of the housing 40 and the surface of the workpiece 12, the air flow running along the workpiece 12 at a high velocity and transporting remnants of cleaning liquid that are deposited thereon by way of the suction connector 58 of the housing 40 and of the valve 62 and of the suction line 60 to the vacuum container 20 in the suction unit 18.

In some examples, vacuum drying can also be performed in the installation 610 prior to a removal of the workpiece 12, such that the valve 76 in the ventilation unit 72 is closed and the valve 56 in the fluid line 50 is closed, and a vacuum in the interior space 16 of the operating chamber 14 is then generated by means of the suction pump 26 of the evacuation unit 24 by way of the vacuum container 20 and of the suction line 60, for example.

In summary, the following preferred features of examples disclosed herein are to be described: some examples disclosed herein relate to an installation 10, 110, 210, 310, 410, 510, 610 for the treatment of a workpiece 12 with a process fluid 49, having a workpiece receptacle region 42 for receiving the workpiece 12, and having a unit 46 for impinging the workpiece 12 in the workpiece receptacle region 42 with the process fluid 49. The installation 10, 110, 210, 310, 410, 510, 610 includes a closable operating chamber 14 that is impingeable with at least a partial vacuum, a housing 40, disposed in the operating chamber 14 having a suction connector 58, where the housing surrounds a workpiece 12 that is received in the workpiece receptacle region 42, and a suction device 18 that is connected to the suction connector 58 via a suction line 60.

As mentioned above, it is an object of examples disclosed herein is to provide an installation for the residual-free treatment of a workpiece with a process fluid, and to provide a treatment method for the treatment of workpieces with a process fluid, in which method process-fluid remnants on the workpiece have been removed to a large extent after the treatment.

This object can be achieved by an installation of the type mentioned at the outset, which includes a closable operating chamber that is impingeable with a partial vacuum, and has a housing disposed in an interior space of the operating chamber and a suction connector. for the housing is implemented to surround a workpiece that is received in the workpiece receptacle region, where the suction connector is coupled to a suction device via a suction line.

In some examples, an operating chamber that is impingeable with at least a partial vacuum is understood to be a chamber in which a vacuum having a pressure of at least 250 mbar, preferably 400 mbar and particularly preferably 500 mbar, lower than atmospheric pressure that surrounds the chamber. The vacuum is produced via suction in some examples. The operating chamber in an installation according to examples disclosed herein can be designed, in particular, as a vacuum chamber that is closable in a relatively fluid-tight manner and in which a vacuum that is suitable for vacuum drying can be generated. In some examples, a vacuum which as far as possible is up to 750 mbar and preferably up to 1000 mbar lower than the atmospheric pressure about the chamber can be produced by suction.

In some examples, the process fluid for impinging the workpiece is a liquid or a gas. The process fluid can be vaporous and be composed of hot water vapor, for example. In particular, the process fluid for impinging the workpiece can be a cleaning liquid, such as for example, a cleaning liquid that can dissolve oil adhering to a workpiece or cooling lubricants adhering to a workpiece. Additionally or alternatively, it is to be noted that the process fluid for impinging the workpiece in the installation can, in particular also, include a cooling lubricant or oil.

Examples disclosed herein are based on the concept that cleaning of workpieces by way of a combination of jet cleaning and subsequent vacuum suctioning leads to very positive cleaning results and that in particular bores and blind bores in workpieces can be particularly readily cleaned in this way.

By suctioning the suction line via the suction device, a vacuum can then be generated at the suction connector of the housing. It can be achieved in this manner that liquid media deposited in the housing or on a workpiece can be rapidly evaporated and released from the workpiece. A workpiece that is disposed in the workpiece receptacle region and within the housing herein preferably causes (by displacement effects) a reduction in the fluid volume that is located in the housing, for example.

It is also an aspect of examples disclosed herein that a vacuum causes a fluid flow from the interior of the housing into the suction line. The fluid flow impinges a workpiece that is disposed in the workpiece receptacle region. The fluid flow is generated at the suction connector of the housing by suctioning the suction line by way of the suction device. Examples disclosed herein can exploit spaces such as flow ducts having an available cross section that is reduced in relation to the environment are formed between a workpiece disposed in the housing and the housing, for example. The fluid flow in the housing is guided in such examples in the workpiece receptacle region through one or a plurality of constrictions in which said fluid flow on its path into the suction line in portions is accelerated, decelerated again and/or deflected.

An aspect of examples disclosed herein is also that the housing includes a housing wall with at least one passage opening for a gaseous fluid, through which the gaseous fluid is able to be sucked into the housing via the suction device by generating a vacuum at the suction connector. In some examples, when a vacuum is generated at the suction connector of the housing, a pressure differential is created between the at least one passage opening and the suction connector such that a fluid flow from the passage opening to the suction connector is created through the housing in such examples.

According to examples disclosed herein, fluid flow runs at least in portions along the workpiece to be dried. By virtue of the dynamic pressure that depends on the velocity of the fluid flow, the static pressure on the surfaces of the workpiece to be dried herein is also changed and reduced at least in portions. It has been recognized that in examples where static pressure is reduced in such a manner, liquid drops deposited on the surface of a workpiece can be removed in a particularly effective manner by virtue of the flow velocity of the fluid flow.

Constrictions at which the flow velocity of the fluid flow reaches a relative maximum such that the desired drying effect is particularly intensive are preferably formed in portions between the housing and a workpiece. It is also an aspect of examples disclosed herein to guide the fluid flow in the housing through cavities of a workpiece, in which cavities the fluid flow is likewise accelerated in a localized manner. It is advantageous in some examples for the suction device in the installation to include a vacuum container that is ventable via the suction line, and an evacuation unit for evacuating the vacuum container. Accordingly, it is possible for relatively large quantities of gas to be suctioned from the housing in a relatively short time, such that a strong fluid flow is generated quickly therein. To release and block the suction line in a preferably abrupt manner, the installation preferably has a valve that is configured as a flap valve, in some examples.

It is an aspect of examples disclosed herein that the housing that surrounds the workpiece receptacle region is disposed in an operating chamber that is closable in a fluid-tight manner. Thus, the installation workpieces can be pre-dried in the housing by impingement with a relatively strong fluid flow, and after pre-drying subjecting to vacuum drying by evacuating the operating chamber. Thus, for the impingement of a workpiece with a fluid flow in the operating chamber by applying a vacuum to the suction connector of the housing that a part-vacuum can be configured in the operating chamber. In some examples, setting a higher vacuum that facilitates vacuum drying in the operating chamber is then possible at a reduced effort in terms of energy and time.

To evacuate the operating chamber, the evacuation unit can include a suction pump that is connected on the suction side to the operating chamber via a fluid line. In some examples, it is advantageous for the installation to also have a line for evacuating the vacuum container, where the line on the suction side communicating with the suction pump includes the fluid line. In this way, the evacuation unit can be employed both for evacuating the vacuum container and evacuating the operating chamber.

In some examples, the installation preferably includes a ventilation unit for venting the operating chamber. In some examples, the ventilation unit preferably includes a valve that selectively releases or blocks a flow path for fluid that leads into the interior of the operating chamber.

In some examples, in that the process fluid for impinging the workpiece is sprayed or atomized onto the workpiece, the preliminary release of contaminants can be facilitated by way of suitable components in the process fluid. These contaminants can then be discharged from the operating chamber in a vacuum suction flow and collected for disposal in the vacuum container.

It is also an aspect of examples disclosed herein to pre-dry workpieces in the operating chamber by the suction flow. According to examples disclosed herein, a workpiece in the operating chamber, preferably after pre-drying in the suction flow, can be subjected to vacuum drying.

In some examples, the housing in the operating chamber can be implemented in the shape of a tunnel, for example. In such examples, a linear motion unit for the linear displacement of workpieces through the housing is preferably provided in the housing to move the workpieces from a first closable opening of the operating chamber to a further opening of the operating chamber that is opposite the first opening. As a result, drying of workpieces in the installation with relatively short cycle times is enabled in this way.

In some examples, it is advantageous for the installation to include a housing that has a first portion, which is displaceable for disposing workpieces in the workpiece receptacle region in relation to a second portion of the housing. The disposal of workpieces in the housing of the installation can be simplified in this manner. It is particularly advantageous in some examples for the operating chamber to have a first chamber part having the portion of the housing fixed therein, and a further chamber part that is displaceable between a closed and an opened position in relation to the first chamber part and has a further portion of the housing fixed therein for the workpiece receptacle region in the opened position to be released for feeding and discharging workpieces and, in the closed position, to lock a workpiece that is disposed in the workpiece receptacle region in the housing.

It is a concept of examples disclosed herein that bores and threaded blind bores cannot be readily cleaned without targeted jet cleaning. In some examples, the unit for impinging the workpiece in the workpiece receptacle region with the process fluid therefore preferably includes at least one nozzle for impinging the workpiece with the process fluid by way of at least one nozzle opening that is disposed in the housing. The nozzle for impinging the workpiece can be a spray nozzle, for example. Additionally or alternatively, the unit for impinging the workpiece in the workpiece receptacle region with the process fluid can include at least one nozzle tool having at least one nozzle, where the nozzle tool is disposable in a recess and/or a bore of the workpiece.

An aspect of examples disclosed herein is that the unit for impinging the workpiece in the workpiece receptacle region with the process fluid includes a fluid line for feeding process fluid to the at least one nozzle. To impinge the process fluid with an operating pressure, pA, a pressure generator is preferably disposed in this fluid line in some examples. Particularly preferably, a shut-off valve may be implemented in the fluid line. An installation according to examples disclosed herein can also include a further suction line for suctioning the fluid line on a side of the shut-off valve that faces the at least one nozzle communicates with the fluid line. It is also an aspect of examples disclosed herein that the housing is adapted to the external contour of the workpiece. Accordingly, the quantity of fluid which for setting a vacuum in the operating chamber and for generating a fluid flow through the housing to be conveyed in the installation can be reduced.

Examples disclosed herein also relate to a method for the treatment of a workpiece. The method including disposing the workpiece in a workpiece receptacle region in a housing, which is located in an interior space of an operating chamber; impinging the workpiece with a process fluid in the workpiece receptacle region; and, subsequently, impinging the workpiece with a gaseous fluid flow by applying a vacuum to the operating chamber. Examples disclosed herein also relate to a method in which impinging the workpiece with a process fluid in the workpiece receptacle region includes jet-cleaning of the workpiece with process fluid in the form of a cleaning liquid and/or subsequent vacuum drying of the workpiece to be carried out in the operating chamber.

An example installation 10 for the treatment of a workpiece 12 with a process fluid 49 includes a workpiece receptacle region 42 for receiving the workpiece 12, and a unit 46 for impinging the workpiece 12 in the workpiece receptacle region 42 with the process fluid 49, a closable operating chamber 14 which is impingeable at least with a part-vacuum, a housing 40, disposed in an interior space 16 of the operating chamber 14, having a suction connector 58, the housing 40 serving for surrounding a workpiece 12 which is received in the workpiece receptacle region 42, and a suction device 18 that is connected to the suction connector 58 by a suction line 60.

The housing 40 has a first portion 68 which is displaceable for disposing workpieces 12 in the workpiece receptacle region 42 in relation to a second portion 70 of the housing 40; and/or in that the operating chamber 14 has a first chamber part 64 having the portion 68 of the housing 40 fixed therein, and a further chamber part 66 that is displaceable between a closed and an opened position in relation to the first chamber part 64 and has a further portion 70 of the housing 40 fixed therein, in order for the workpiece receptacle region 42 in the opened position to be released for feeding and discharging workpieces 12 and in the closed position to lock a workpiece 12 that is disposed in the workpiece receptacle region 42 in the housing 40.

In some examples, a vacuum which causes a fluid flow 80 into the suction line 60, said fluid flow 80 impinging a workpiece 12 that is disposed in the workpiece receptacle region 42, is generatable at the suction connector 58 of the housing 40 by suctioning the suction line 60 by way of the suction device 18.

In some examples, the housing 40 has a housing wall having at least one passage opening 44 for a gaseous fluid, through which the gaseous fluid is able to be sucked into the housing 40 by way of the suction device 18 by generating a vacuum at the suction connector 58.

In some examples, the suction device 18 has a vacuum container 20 that is ventable by way of the suction line 60, and an evacuation unit 24 for evacuating the vacuum container 20.

Some examples include a valve 62 for releasing and blocking the suction line 60.

Some examples include a ventilation unit 72 for venting the operating chamber 14.

In some examples, the ventilation unit 72 includes a valve 76 which selectively releases or blocks a flow path for fluid that leads into the interior space 16 of the operating chamber 14.

In some examples, the unit for impinging the workpiece 12 in the workpiece receptacle region 42 with the process fluid 49 includes at least one nozzle 52 for impinging the workpiece 12 with the process fluid 49 by way of at least one nozzle opening 55 that is disposed in the housing 40.

In some examples, the unit for impinging the workpiece 12 in the workpiece receptacle region 42 with the process fluid 49 includes at least one nozzle tool 81 having at least one nozzle 52, said nozzle tool 81 being disposable in a recess and/or a bore of the workpiece 12.

In some examples, the unit for impinging the workpiece 12 in the workpiece receptacle region 42 with the process fluid 49 includes a fluid line 50 for feeding process fluid 49 to the at least one nozzle 52.

In some examples, for impinging the process fluid 49 with an operating pressure pA, a pressure generator 54 is disposed in the fluid line 50; and/or a shut-off valve 56 is disposed in the fluid line 50; and/or a further suction line 60 is provided which for suctioning the fluid line 50 on a side of the shut-off valve 56 that faces the at least one nozzle 52 communicates with the fluid line 50.

In some examples, the housing 40 is adapted to the external contour of the workpiece 12.

An example method for the treatment of a workpiece 12 includes disposing the workpiece 12 in a workpiece receptacle region 42 in a housing 40 which is located in an interior space 16 of an operating chamber 14 that is impingeable at least with a part-vacuum, impinging the workpiece 12 with a process fluid 49 in the workpiece receptacle region 42; and subsequently impinging the workpiece 12 with a gaseous fluid flow 80 by applying a vacuum to the operating chamber 14.

In some examples, impinging the workpiece 12 with a process fluid 49 in the workpiece receptacle region 42 comprises jet-cleaning of the workpiece 12 with process fluid 49 in the form of a cleaning liquid and/or subsequent vacuum drying of the workpiece 12 is carried out in the operating chamber 14.

This patent arises as a continuation-in-part of International Patent Application No. PCT/EP2016/066507, which was filed on Jul. 12, 2016, which claims priority to German Patent Application No. 10 2015 215 728, which was filed on Aug. 18, 2015. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An installation for the treatment of a workpiece with a process fluid, the installation comprising:
a workpiece receptacle region for receiving the workpiece;
an impingement unit for impinging the workpiece in the workpiece receptacle region with the process fluid;
a closable operating chamber that is provided with at least a partial vacuum;
a housing disposed in an interior space of the operating chamber, the housing including a suction connector, the housing to surround a workpiece that is received in the workpiece receptacle region; and
a suction device that is coupled to the suction connector via a suction line,
wherein at least one of:
the housing includes a first portion that is displaceable for disposing workpieces in the workpiece receptacle region relative to a second portion of the housing, or
the operating chamber includes a first chamber part having the portion of the housing fixed therein, and a further chamber part that is displaceable between a closed and an opened position relative to the first chamber part, the operating chamber including a further portion of the housing fixed therein for the workpiece receptacle region in the opened position to be released for feeding and discharging workpieces and in the closed position to lock a workpiece that is disposed in the workpiece receptacle region in the housing.

2. The installation as defined in claim 1, wherein a vacuum that causes a fluid flow into the suction line, and wherein the fluid flow is to impinge a workpiece that is disposed in the workpiece receptacle region, the fluid flow generated at the suction connector of the housing by suctioning the suction line via the suction device.

3. The installation as defined in claim 1, wherein the housing includes a housing wall having at least one passage opening for a gaseous fluid, through which the gaseous fluid is able to be sucked into the housing via the suction device by generating a vacuum at the suction connector.

4. The installation as defined in claim 1, wherein the suction device includes a vacuum container that is ventable via the suction line, and an evacuation unit for evacuating the vacuum container.

5. The installation as defined in claim 4, further including a valve for releasing and blocking the suction line.

6. The installation as defined in claim 1, further including a ventilation unit for venting the operating chamber.

7. The installation as defined in claim 6, wherein the ventilation unit includes a valve that selectively releases or blocks a flow path for fluid that leads into the interior space of the operating chamber.

8. The installation as defined in claim 1, wherein the impingement unit includes at least one nozzle to impinge the workpiece with the process fluid via at least one nozzle opening that is disposed in the housing.

9. The installation as defined in claim 8, wherein the impingement unit includes a fluid line for feeding process fluid to the at least one nozzle.

10. The installation as defined in claim 9, wherein for impinging the process fluid with an operating pressure, p_{A}, at least one of:
a pressure generator is disposed in the fluid line or a shut-off valve is disposed in the fluid line, or
a further suction line is provided which for suctioning the fluid line on a side of the shut-off valve that faces the at least one nozzle fluidly communicates with the fluid line.

11. The installation as defined in claim 1, wherein the impingement unit includes at least one nozzle tool having at least one nozzle, the nozzle tool being disposable in at least one of a recess or a bore of the workpiece.

12. The installation as defined in claim 11, wherein the impingement unit includes a fluid line for feeding process fluid to the at least one nozzle.

13. The installation as defined in claim 1, wherein the housing is adapted to the external contour of the workpiece.

14. A method for the treatment of a workpiece, the method comprising:
disposing the workpiece in a workpiece receptacle region in a housing that is disposed in an interior space of an operating chamber, wherein the interior space is to be provided with at least a partial vacuum, wherein at least one of
the housing includes a first portion that is displaceable for disposing workpieces in the workpiece receptacle region relative to a second portion of the housing, or
the operating chamber includes a first chamber part having the portion of the housing fixed therein, and a further chamber part that is displaceable between a closed and an opened position relative to the first chamber part, the operating chamber including a further portion of the housing fixed therein for the workpiece receptacle region in the opened position to be released for feeding and discharging workpieces and in the closed position to lock a workpiece that is disposed in the workpiece receptacle region in the housing;
impinging the workpiece with a process fluid in the workpiece receptacle region; and
impinging the workpiece with a gaseous fluid flow by applying a vacuum to the operating chamber.

15. The method as defined in claim 14, wherein impinging the workpiece with the process fluid in the workpiece receptacle region includes jet-cleaning the workpiece with process fluid in the form of at least one of a cleaning liquid or subsequent vacuum drying of the workpiece that is carried out in the operating chamber.

16. An installation for the treatment of a workpiece with a process fluid, the installation comprising:
a workpiece receptacle region for receiving the workpiece;
an impingement unit for impinging the workpiece in the workpiece receptacle region with the process fluid, wherein the impingement unit includes at least one nozzle tool having at least one nozzle, the nozzle tool being disposable in at least one of a recess or a bore of the workpiece, wherein the impingement unit includes a fluid line for feeding process fluid to the at least one nozzle, wherein for impinging the process fluid with an operating pressure, p_{A}, at least one of:
a pressure generator is disposed in the fluid line or a shut-off valve is disposed in the fluid line, or
a further suction line is provided which for suctioning the fluid line on a side of the shut-off valve that faces the at least one nozzle fluidly communicates with the fluid line;
a closable operating chamber that is provided with at least a partial vacuum;
a housing disposed in an interior space of the operating chamber, the housing including a suction connector, the housing to surround a workpiece that is received in the workpiece receptacle region, wherein the housing is adapted to the external contour of the workpiece; and
a suction device that is coupled to the suction connector via a suction line,
wherein at least one of:
the housing includes a first portion that is displaceable for disposing workpieces in the workpiece receptacle region relative to a second portion of the housing, or
the operating chamber includes a first chamber part having the portion of the housing fixed therein, and a further chamber part that is displaceable between a closed and an opened position relative to the first chamber part, the operating chamber including a further portion of the housing fixed therein for the workpiece receptacle region in the opened position to be released for feeding and discharging workpieces and in the closed position to lock a workpiece that is disposed in the workpiece receptacle region in the housing.

17. An installation for the treatment of a workpiece with a process fluid, the installation comprising:
a workpiece receptacle region for receiving the workpiece;
an impingement unit for impinging the workpiece in the workpiece receptacle region with the process fluid, wherein the impingement unit includes a fluid line for feeding process fluid to at least one nozzle, wherein for impinging the process fluid with an operating pressure, p_{A}, at least one of:
a pressure generator is disposed in the fluid line or a shut-off valve is disposed in the fluid line, or
a further suction line is provided which for suctioning the fluid line on a side of the shut-off valve that faces the at least one nozzle fluidly communicates with the fluid line;
a closable operating chamber that is provided with at least a partial vacuum;
a housing disposed in an interior space of the operating chamber, the housing including a suction connector, the housing to surround a workpiece that is received in the workpiece receptacle region, wherein the housing is adapted to the external contour of the workpiece; and
a suction device that is coupled to the suction connector via a suction line,
wherein at least one of:
the housing includes a first portion that is displaceable for disposing workpieces in the workpiece receptacle region relative to a second portion of the housing, or
the operating chamber includes a first chamber part having the portion of the housing fixed therein, and a further chamber part that is displaceable between a closed and an opened position relative to the first chamber part, the operating chamber including a further portion of the housing fixed therein for the workpiece receptacle region in the opened position to be released for feeding and discharging workpieces and in the closed position to lock a workpiece that is disposed in the workpiece receptacle region in the housing.
